(19) United States
(12) Patent Application Publication
(10) Pub. No.: US 2019/0112160 A1
(43) Pub. Date: Apr. 18, 2019

(54) BALUSTRADE FOR A PEOPLE CONVEYOR

(71) Applicant: Otis Elevator Company, Farmington, CT (US)

(72) Inventor: Murali Veeraraghavan, Guduvanchery (IN)

(21) Appl. No.: 16/161,388

(22) Filed: Oct. 16, 2018

(30) Foreign Application Priority Data
Oct. 18, 2017 (EP) 17197050.2

(51) Int. Cl. B66B 23/22; B66B 21/02; B66B 21/10; B66B 27/00; B66B 25/00

(52) U.S. Cl. CPC B66B 23/22; B66B 21/02; B66B 25/006; B66B 27/00; B66B 21/10

(57) ABSTRACT

A balustrade (5) for a people conveyor (2) comprising a conveyance portion extending in a conveying direction between two landing portions (3, 9) comprises a base portion (5a) which is at least partially covered by a pressure sensitive coating (17), in particular a pressure sensitive paint (17).

The application is related to a balustrade for a people conveyor comprising a safety mechanism.

People conveyors, such as escalators and moving walkways, usually comprise a conveyance band, which is configured for conveying passengers, and at least one balustrade extending parallel to the conveyance band. The at least one balustrade supports a moving handrail element and includes a base portion extending along a lateral side of the conveyance band.

There is some risk that shoes or cloths of passengers riding on the conveyance band get stuck between the moving conveyance band and the stationary base portion of the balustrade.

It therefore would be beneficial to provide a balustrade and a people conveyor which allow reducing said risk of entrapment.

According to an exemplary embodiment of the invention, a balustrade for a people conveyor, which comprises a conveyance portion extending in a conveying direction between two landing portions, has a base portion which is at least partially covered by a pressure sensitive coating, in particular a pressure sensitive paint, more particularly a piezo-electric paint.

Exemplary embodiments of the invention also include a people conveyor, such as an escalator or a moving walkway, comprising such a balustrade. In such a people conveyor the balustrade is arranged at a lateral side of the conveyance element and the pressure sensitive coating is applied to a surface of the base portion of the balustrade facing the at least one conveyance element.

The pressure sensitive coating applied to at least a part of the base portion allows reliably detecting items, in particular shoes of passengers, touching the base portion of the balustrade. Thus, appropriate actions may be taken in order to prevent these items from being entrapped between the stationary base portion of the balustrade and the moving conveyance band.

Applying a pressure sensitive coating to the base portion of the balustrade is an easy measure which does not require any considerable redesign of the people conveyor as it does not change the dimensions of the balustrade.

A number of optional features are set out in the following. These features may be realized in particular embodiments, alone or in combination with any of the other features.

The balustrade may comprise at least two electrodes which are in electric contact with the pressure sensitive coating in order to allow detecting electric signals generated by the pressure sensitive coating.

Additional electrodes, in particular pairs of electrodes may be applied along the length of the base portion in order to allow detecting the position at which the base portion is touched more specifically.

The balustrade may comprise at least one brush extending along the conveying direction, and the pressure sensitive coating may be applied to an area of the balustrade which is located below said at least one brush. The risk of entrapment is most significant in the area below the at least one brush. Thus, applying the pressure sensitive coating in said area results in an efficient detection of potential entrapment situations using only a relatively small amount of pressure sensitive coating. It further reduces the risk of false alarms triggered by passengers touching an upper portion of the balustrade, where there is no risk of entrapment.

The pressure sensitive coating may be applied to the balustrade in at least one of the landing zones in order to detect potential entrapment situations in the landing zone(s). The risk of entrapment is particularly significant in the landing zones where the conveyance band passes a comb plate and passengers enter and leave the passenger conveyor, respectively.

In order to reduce the amount of pressure sensitive coating needed and/or in order to reduce the risk of false alarms, the pressure sensitive coating may be applied only in the landing zones. Alternatively or additionally, the pressure sensitive coating may be applied to the balustrade in the conveyance portion of the people conveyor.

An undercoating may be sandwiched between the base portion and the pressure sensitive coating. The undercoating may be configured for electrically isolating the pressure sensitive coating from the base portion and/or it may be configured for providing a better adhesion of the pressure sensitive coating.

Additionally or alternatively, the pressure sensitive coating may be covered by a protective coating which is configured for protecting the pressure sensitive coating from damage and/or wear caused by mechanical contact and/or moisture.

The people conveyor may comprise a detection unit, which is electrically connected with the at least two electrodes. The detection unit may be configured for detecting an electric signal, in particular an electric voltage, which is generated by the pressure sensitive coating. The detection unit in particular may be configured for issuing an alarm signal in case the detected signal/voltage exceeds a predetermined alarm threshold.

The detection unit in particular may be configured to issue at least one of an electric alarm signal, an acoustic alarm signal and an optical alarm signal. An acoustic and/or optical alarm signal may notify the passenger about the detected potential dangerous situation in order to motivate the passenger to remove his/her shoe or cloth from the lower portion of the balustrade.

The people conveyor may further comprise a control unit, which is configured to stop movement of the people conveyor in case an alarm signal has been issued in order to avoid a situation of entrapment, in particular in case the passenger does not react to a previously issued alarm signal.

The control unit in particular may be configured to stop the people conveyor in case the alarm signal has been issued for more than a predetermined period of time.

Alternatively or additionally, the control unit may be configured to stop movement of the people conveyor in case the detected electric signal exceeds a stopping threshold which may be larger than the alarm threshold. Such a situation may occur in case an item, in particular a shoe of a passenger, is pressed against the lower portion of the balustrade with a force which is bigger than the force necessary for causing an alarm signal to be issued.

In the following an exemplary embodiment of the invention is described with reference to the enclosed figures.

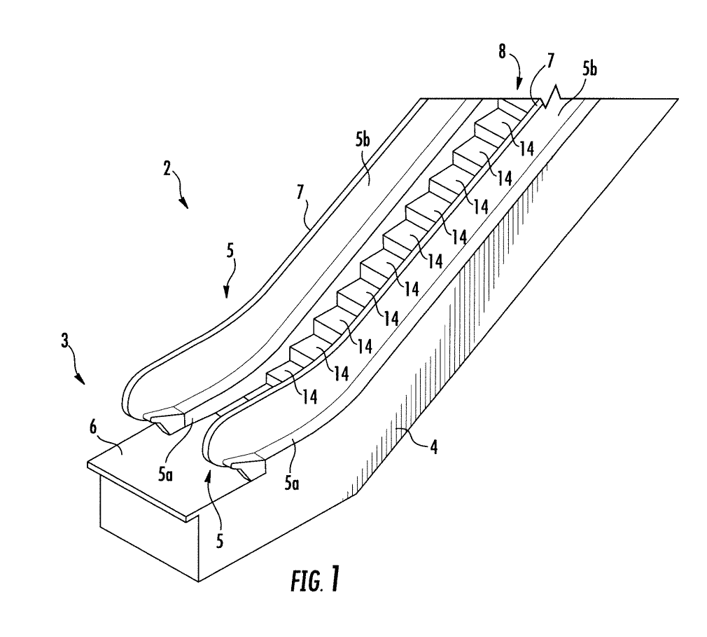

FIG. 1 shows a perspective view of a lower portion of a people conveyor to which exemplary embodiments of the invention may be applied.

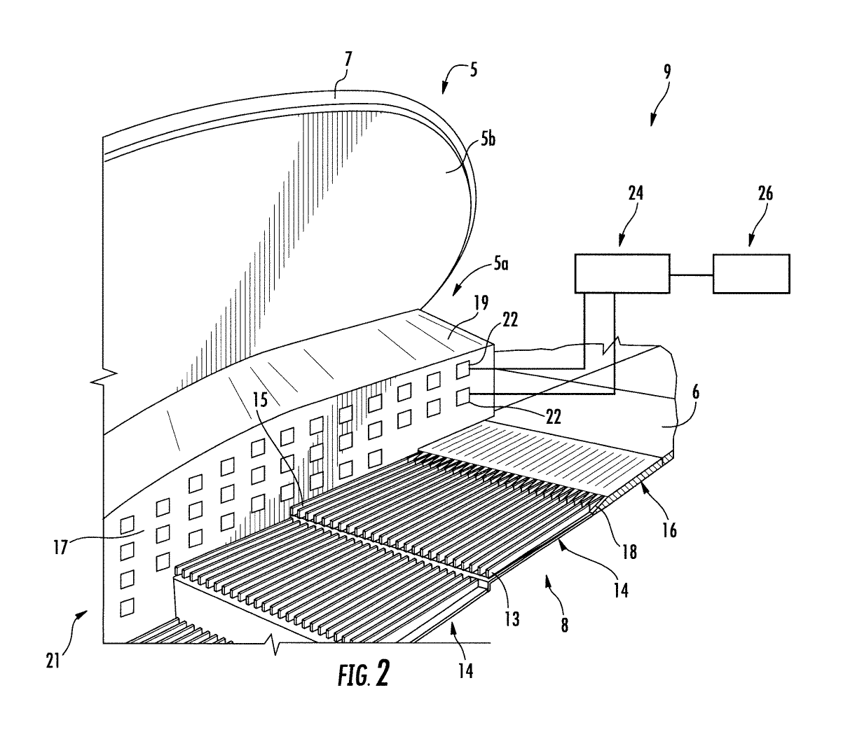

FIG. 2 shows an enlarged perspective view of a portion of the people conveyor.

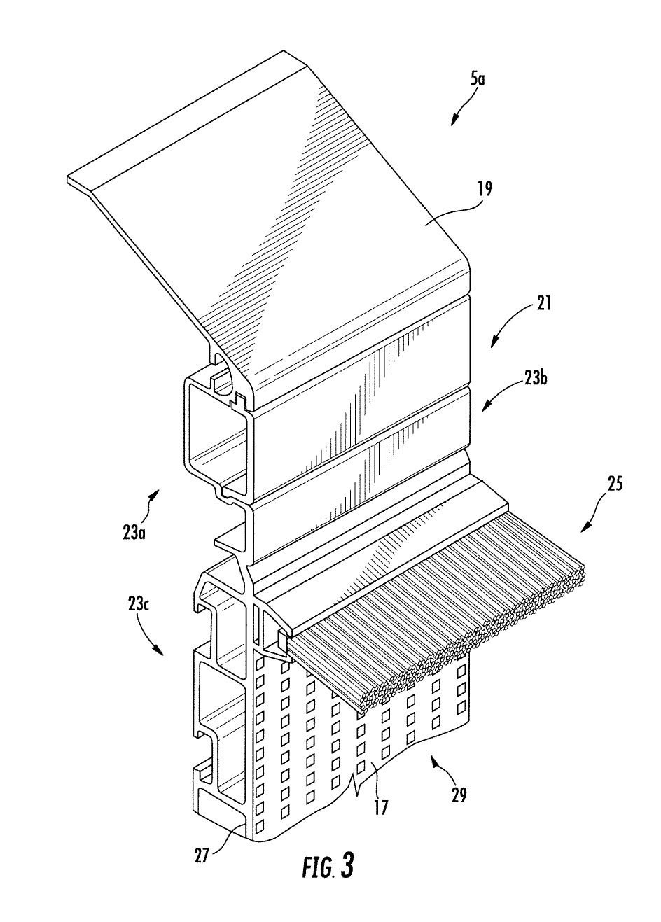

FIG. 3 shows an enlarged perspective view of a section of a balustrade according to an exemplary embodiment of the invention.

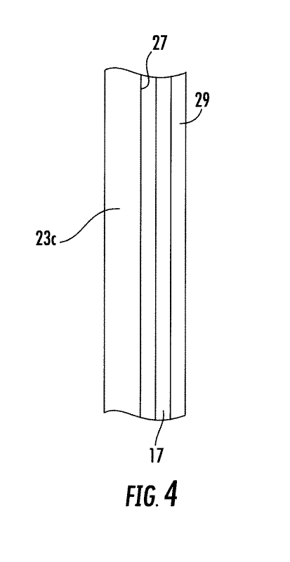

FIG. 4 schematically shows a portion of the balustrade covered by a sandwich structure including an undercoating, a pressure sensitive coating and a protective coating.

FIG. 1 shows a perspective view of a portion of a people conveyor 2 according to an exemplary embodiment of the invention.

The people conveyor 2 shown in FIG. 1 is an escalator. The people conveyor 2 comprises a truss 4 extending in a (longitudinal) conveying direction between a lower landing zone 3 comprising a floor plate 6 and a corresponding upper landing zone 9 (see FIG. 2), which is not shown in FIG. 1.

The truss 4 supports a chain of conveyance elements 14 forming a conveyance band 8, and two balustrades 5 extending parallel to the conveyance band 8. In case of an escalator, as it is shown in FIG. 1, the conveyance elements 14 are steps 14 so that the conveyance band 8 is a chain of steps 14. The balustrades 5 reside laterally at both sides of the conveyance band 8. Each balustrade 5 comprises a base portion 5a extending parallel to a lateral side of the conveyance band 8 and an upper portion 5b, which is supported by the base portion 5a and supports a moving handrail 7.

The base portion 5a is usually made of metal. The upper portion 5b may be made of metal or a transparent material such as glass or acrylic glass. The upper portion 5b may extend in a vertical direction, as shown in FIG. 1, or it may be inclined with respect to the vertical direction.

Although the people conveyor 2 shown in FIG. 1 is an escalator comprising a plurality of steps 14, the skilled person will understand that the ideas and principles described in the following may be applied to horizontal and inclined moving walkways comprising pallets instead of steps 14 and to any other types of people conveyors 2 as well.

FIG. 2 shows an enlarged perspective view of the upper landing zone 9, which is not shown in FIG. 1.

FIG. 2 in particular illustrates that an upper surface of each of the steps 14 is provided with a plurality of alternating grooves 15 and cleats 13 extending in the conveyance direction.

A comb plate 16 is arranged next to floor plate 6 on the side of the floor plate 6 facing the conveyance band 8. The comb plate 16 comprises a plurality of teeth 18 extending parallel to the conveyance direction. The teeth 18 are in a staggered relation with the cleats 13 of the steps 14 and extend into the grooves 15 formed on the upper surfaces of the steps 14.

The base portion 5a has a front surface 21 facing the steps 14. In case an item, such as a shoe of a passenger (not shown) standing on the steps 14, touches said front surface 21, there is some risk that the item is entrapped between the moving steps 14 and the stationary front surface 21 of the base portion 5a.

According to an embodiment of the invention, the front surface 21 is at least partially covered with a pressure sensitive coating 17, in particular a pressure sensitive paint, more particularly a piezo-electric paint, which is configured for generating an electric potential when subjected to pressure.

At least two electrodes 22 are in electric contact with the pressure sensitive coating 17 at at least two different locations. In case pressure is applied to the pressure sensitive coating 17, in particular by a shoe of a passenger touching the base portion 5a of the balustrade 5, an electric voltage is generated between the two electrodes 22.

The electrodes 22 are electrically connected to a detection unit 24. The detection unit is configured for detecting an electric signal, in particular an electric voltage generated by the pressure sensitive coating 17 and for issuing an alarm signal in case the detected signal (voltage) exceeds a predetermined alarm threshold.

The detection unit 24 in particular may be configured to issue an acoustic alarm signal and/or an optical alarm signal for notifying the passenger about the potentially dangerous situation and causing the passenger to remove his/her shoe or any other item from the lower portion 5a of the balustrade 5.

The people conveyor 2 further comprises a control unit 26, which is configured for controlling the operation of the people conveyor 2. The control unit 26 in particular may be configured to stop movement of the conveyance band 8 in case an alarm signal has been issued by the detection unit 24.

The control unit 26 in particular may be configured to stop the conveyance band 8 in case the alarm signal has been issued for at least a predetermined period of time.

Alternatively or additionally, the control unit 26 may be configured to stop the people conveyor in case the detected voltage exceeds a stopping threshold. The stopping threshold may be larger than the alarm threshold in order to stop the conveyance band 8 in case a bigger force/pressure is detected by the pressure sensitive coating 17.

FIG. 3 shows a detailed perspective sectional view of a section of a base portion 5a of a balustrade 5 according to an exemplary embodiment of the invention.

The base portion 5a comprises an upper inclined skirt portion 19 and a vertical front surface 21 formed by a combination of structural elements 23a, 23b, 23c, which are securely connected to each other. A brush 25, which is not shown in FIGS. 1 and 2, is mounted to one of the structural elements 23c. The brush 25 faces the steps 14, which are not shown in FIG. 3, for preventing items/shoes from touching the front surface 21. The pressure sensitive coating 17 is applied to a portion of the front portion 21 below the brush 25, as this is the part of the base portion 5a providing the highest risk of entrapment.

An undercoating 27, in particular an electrically isolating and/or adhesive undercoating 27, may be applied below the pressure sensitive coating 17 in order to electrically isolate the pressure sensitive coating 17 from the respective structural element 23c and/or cause a better adhesion of the pressure sensitive coating 17.

Additionally or alternatively, the pressure sensitive coating 17 may be covered with a protective coating 29 in order to protect the pressure sensitive coating 17 from damage and/or wear caused by mechanical contact and/or moisture.

FIG. 4 schematically shows a section of structural element 23c covered by a sandwich structure including the undercoating 27 applied to a surface of the structural element 23c, the pressure sensitive coating 17 applied to the undercoating 27 and the protective coating 29 covering the pressure sensitive coating 17.

The pressure sensitive coating 17 may be applied along the whole length of the base portion 5a. Additional electrodes 22, in particular pairs of electrodes 22, may be applied along the length of the base portion 5a in order to allow detecting the position, at which the base portion 5a is touched, more specifically.

In an alternative embodiment, the pressure sensitive coating 17 may be applied only to selected sections of the base portion 5a along the longitudinal direction, in particular in sections in which the risk of entrapment is high, such as sections close to the landing portions 3, 9.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention includes all embodiments falling within the scope of the dependent claims.

### REFERENCES

2 people conveyor

3 lower landing zone

4 truss

5 balustrade

5a base portion of the balustrade

5b upper portion of the balustrade

6 floor plate

7 handrail element

8 conveyance band

9 upper landing zone

13 cleat

14 conveyance element/step

15 groove

16 comb plate

17 pressure sensitive coating

18 teeth

19 skirt portion

21 front portion

23a, 23b, 23c structural elements

24 detection unit

26 control unit

27 undercoating

29 protective coating

What is claimed is:

1. Balustrade (5) for a people conveyor (2) comprising a conveyance portion extending in a conveying direction between two landing portions (3, 9),
the balustrade (5) comprising a base portion (5a) which is at least partially covered by a pressure sensitive coating (17), in particular a pressure sensitive paint.

2. Balustrade (5) according to claim 1, further comprising at least two electrodes (22) in electric contact with the pressure sensitive coating (17).

3. Balustrade (5) according to claim 2, comprising more than two electrodes (22) in electric contact with different areas of the pressure sensitive coating (17).

4. Balustrade (5) according to claim 1, comprising at least one brush (25) extending along the conveying direction, wherein the pressure sensitive coating (17) is applied to an area of the balustrade (5) below said at least one brush (25).

5. Balustrade (5) according to claim 1, wherein the pressure sensitive coating (17) is applied to the base portion (5a) in at least one of the landing zones (3, 9).

6. Balustrade (5) according to claim 1, wherein the pressure sensitive coating (17) is applied to the base portion (5a) in the conveyance portion.

7. Balustrade (5) according to claim 1, further comprising an undercoating (27) sandwiched between the base portion (5a) and the pressure sensitive coating (17).

8. Balustrade (5) according to claim 1, further comprising a protective coating (29) covering the pressure sensitive coating (17).

9. People conveyor comprising at least one conveyance element (14) and at least one balustrade (5) according to claim 1, wherein the balustrade (5) is arranged at a lateral side of the at least one conveyance element (14) and the pressure sensitive coating (17) is applied to a surface (21) of the balustrade (5) facing the at least one conveyance element (14).

10. People conveyor according to claim 9, wherein the people conveyor (2) is an escalator or a moving walkway.

11. People conveyor according to claim 9, further comprising a detection unit (24), which is electrically connected with the at least two electrodes (22) and which is configured for detecting an electric signal generated by the pressure sensitive coating (17).

12. People conveyor according to claim 11, wherein the detection unit (24) is configured to issue an alarm signal in case the detected electric signal exceeds a predetermined alarm threshold, wherein the detection unit (24) in particular is configured to issue at least one of an electric alarm signal, an acoustic alarm signal and an optical alarm signal.

13. People conveyor according to claim 11, further comprising a control unit (26), which is configured to stop movement of the at least one conveyance element (14) in case an alarm signal has been issued.

14. People conveyor according to claim 13, wherein the control unit (26) is configured to stop movement of the at least one conveyance element (14) in case the alarm signal has been issued for a predetermined period of time.

15. People conveyor according to claim 13, wherein the control unit (26) is configured to stop movement of the at least one conveyance element (14) in case the detected signal exceeds a stopping threshold which is larger than the alarm threshold.
